(19) United States
(12) Patent Application Publication
(10) Pub. No.: US 2003/0192925 A1
(43) Pub. Date: Oct. 16, 2003

(54) Method and apparatus for transporting a car seat

(76) Inventor: Brian T. Boone, Boulder, CO (US)

Correspondence Address: INTELLECTECH, PLLC, 501 SIXTH STREET, N.E., SUITE 700, WASHINGTON, DC, 20002-5205, US

(21) Appl. No.: 10/443,838

(22) Filed: May 23, 2003

Related U.S. Application Data
(63) Continuation-in-part of application No. 10/309,085, filed on Dec. 4, 2002.
(60) Provisional application No. 60/336,631, filed on Dec. 7, 2001.

(51) Int. Cl. A61G 1/00; A45C 15/00; A45F 3/04; A45F 3/08; A45F 3/10

(52) U.S. Cl. 224/161; 224/160; 224/576; 224/628

(57) ABSTRACT

An apparatus for transporting a car seat such as an infant car seat, child car seat, or a child booster seat is disclosed. The apparatus includes a carrier body and at least one system of harnesses for attaching a wheeled assembly to the car seat. The apparatus with attached car seat may be wheeled on the ground by a person using one hand, or may be carried on a person's back, chest, or side, leaving the person's hands free. The system of harnesses may include an upper harness system, a middle harness system, a shoulder harness system, and a hip harness system. The wheeled assembly may also be attached to the carrier body via a system of attachment straps, including an upper attachment system, middle attachment system, and lower attachment system. The apparatus permits a person to wheel or carry the car seat together with a child secured in the car seat.

### CROSS-REFERENCE TO RELATED APPLICATIONS

This application is Continuation-in-Part and claims priority from prior U.S. Nonprovisional application Ser. No. 10/309,085, filed on Dec. 4, 2002 and entitled “Method and Apparatus for Carrying a Car Seat,” which in turn claims priority from prior U.S. Provisional Application Serial No. 60/336,631, filed on Dec. 7, 2001 and entitled “Method and Apparatus for Carrying an Infant's or Child's Car Seat on an Individuals Back with or without a Child in the Car Seat.” The specification, drawings, and claims of the prior applications are incorporated herein by reference in their entireties.

### FIELD OF THE INVENTION

The present invention relates to transporting a car seat such as an infant car seat, child car seat, or a child booster seat. In particular, the invention relates to a system of harnesses, handles and wheels for transporting a car seat by wheeling it on the ground. The invention further relates to a system of harnesses for carrying a car seat on a person's back, chest, or side, leaving the person's hands free. The present invention also permits a person to transport a car seat together with a child secured in the car seat.

### BACKGROUND OF THE INVENTION

The use of car seats for the safe restraint of infants and children in vehicles is well known. For the safety and comfort of an infant or child, and also to comply with applicable laws requiring the use of car seats for children of specified ages, car seats now are commonly removed from the family vehicle and taken along on travels. For example, a child's car seat may be used for the child in a rental car on the family vacation. In addition, car seats commonly may be used in other modes of transportation, such as airplanes, busses, boats, or trains, to provide a safer and more comfortable seat for young children.

Such use of car seats away from the family vehicle thus requires the transport of the car seats through airport terminals, bus stations, train stations, boat terminals, and the like. The typical infant or child car seat is quite bulky, of an awkward shape, and may weigh between ten and twenty pounds. Thus the physical size, structure, and weight of the car seat make it difficult to carry and for most persons, require the use of both hands. This is particularly necessary if the car seat is carried for a substantial distance.

Various devices have been developed to assist with the transport of car seats, including a wide variety of bags, totes, and cases. Typically these travel bags comprise a zippered sack, with a handle and/or shoulder strap. The car seat may be placed in the sack and then carried from the family vehicle to baggage check, or onto the airplane, bus, etc.

Alternatively, some models of car seats are provided with wheels and a handle, essentially converting the car seat into a stroller so that it can be wheeled through an airport or other area. In addition, stroller-type attachments are made for car seats, again converting the car seat to a stroller-like apparatus that can be wheeled to its destination.

Typically, a child young enough to require the use of a car seat is also too young to walk any considerable distance through an airport terminal, train station, etc. This generally requires that the child also be carried, typically in a stroller, a backpack or front carrier, or simply in the guardian's arms. In addition, travel with young children generally entails transporting various other equipment, such as diaper bags. As a result, persons transporting young children while traveling must potentially negotiate a number of large, awkward items, in addition to the child.

The devices described above, although designed to transport car seats, nonetheless have a number of disadvantages and limitations. For example, even when encased in the travel bag type of carrier, a car seat may be quite cumbersome to carry, often banging against the leg of the person carrying it. Furthermore, it is not possible to carry a child strapped in the car seat when the car seat is encased in this type of travel bag, so the child typically must be carried in addition to the car seat, or placed in a stroller or other carrying device. This is particularly challenging for a single adult traveling with a child.

Car seats that are capable of being converted to stroller-like apparatuses do permit the carrying of the child in the car seat, but require the transporting person to use his or her hands to wheel the car seat/stroller. Typically, the person must use both hands in order to push and/or steer the car seat/stroller apparatus. A further disadvantage of the stroller-like apparatuses is the limited choice in car seats that confronts a consumer who desires a combined car seat/stroller style. Such a consumer is limited to the very few models of car seat that are sold with the wheeled feature. The consumer is not able to select a car seat based on, for example, a rating for safety, comfort, etc. And in the case of stroller-type attachments, these must be detached and stored once the car seat is placed in the airplane, rental car or other seat. Such attachment also add considerable weight to the car seat, further impeding transport of the car seat.

The present invention. comprises several systems of harnesses and straps that may be attached to both a car seat and a wheeled carrier, so that the car seat may then be wheeled on the ground. In an alternate embodiment, the wheeled carrier may be attached directly to one or more of the harness systems, which then attach to the car seat. The harness systems of the present invention need not be removed when the car seat is placed in its destination seat in a vehicle, airplane, train, etc. Instead, the present invention permits easy detachment of the wheeled carrier component, and then the car seat may be securely fastened into a vehicle or other seat using a conventional safety or seat belt restraint, with the harness systems remaining attached to the car seat. In an alternate embodiment, the car seat may be carried on a person's back, chest, or side. As with the wheelable embodiment, the car seat may be secured in the destination seat with the harness systems remaining attached.

In addition to features designed for convenience, the present invention optimizes load-carrying efficiency and comfort for the user. The harness systems of the present invention are attached to a fabric carrier body that is provided with an internal semi-rigid back pad. The back pad, or stiffening member, may also be provided with shaped, semi-rigid aluminum stays. This semi-rigid body frame provides a contoured platform that attaches both to the wheeled carrier and to the car seat, and thus supports the load of the car seat, or car seat plus child. The two wheel design and the extendable handle of the wheeled carrier permit the combined car seat, frame and wheeled carrier to be tipped at an angle and easily wheeled with one hand. Alternatively, when the car seat is carried on the user's back, the load is effectively distributed over a large area of the user's back. The carrier body-may also be provided with a mesh aerospacer fabric for comfort. Thus the design of the present invention avoids single points of excessive pressure on the user's back.

The semi-rigid body frame also provides a means of attachment for the harnesses and wheeled carrier such that the harnesses, wheeled carrier and points of attachment remain stationary as the user transports the car seat, or car seat plus child. In addition, for the embodiment worn on the user's back, the carrier body provides attachment points for a chest strap, multiple adjustment straps for optimizing the fit of the carrier to the user, and an adjustable hip belt. Attachment of the harness systems and adjustable straps to the semi-rigid carrier body permits the user to shift the load and position of the load in order to optimize stability and comfort.

The design of the present invention provides a convenient method of transporting a car seat, while at the same time maximizing the consumers available choice of car seats. This is because the present invention adjusts to fit virtually any commercially available car seat. Thus, the consumer is able to choose a car seat based on safety features, comfort, price, etc., rather than on a feature such as available wheels, found on only a few models of car seat/stroller combinations.

The present invention overcomes limitations of the known devices in that it permits the user to transport the car seat by tipping it at an angle and easily wheeling it with one hand. For the embodiment carried on the user's back, the car seat may be carried without the user having to use his or her hands. The person's hands are thus free to carry other baggage or equipment, or the child, if desired. In addition, either design permits the transporting person to carry the infant or child securely strapped into the car seat. Thus a further benefit of the present invention is that its use obviates the need for an additional stroller, backpack or front carrier to carry the child, reducing the amount of paraphernalia otherwise required to travel with a young child. Because the harness systems of the present invention need not be removed for the car seat to be secured in a vehicle or other seat, there is less equipment to detach, fold, or stow away.

Further, Applicant has designed the present invention to be useable with any commercially available car seat, by virtue of having an adjustable harness system capable of fitting a multiplicity of sizes and configurations of car seat. For example, the upper attachment straps may be provided with attachment mechanisms of varying thickness, in order to fit in car seat slots of different sizes. The user may “mix and match” components of the apparatus, to choose the combination of harness systems that best fits a particular model of car seat.

Additional objects and advantages of the invention are set forth, in part, in the description which follows and, in part, will be apparent to one of ordinary skill in the art from the description and/or from the practice of the invention.

### SUMMARY OF THE INVENTION

In response to the foregoing challenge, Applicant has developed an innovative and efficient system of harnesses, handles and wheels for transporting a car seat. As illustrated in the accompanying drawings and disclosed in the accompanying claims, the invention is an apparatus for transporting a car seat by a person, comprising a carrier body having an upper end and a lower end; a wheeled assembly disposed on the carrier body at the lower end; and at least one harness system attached to the carrier body, for attaching the carrier body to the car seat. The apparatus further comprises at least one attachment system, for attaching the wheeled assembly to the carrier body. The at least one harness system may further comprise a middle harness system attached to the carrier body between the upper end and the lower end, for attaching the carrier body to the car seat, and the at least one harness system may further comprise an upper harness system attached to the carrier body at the upper end, for further attaching the carrier body to the car seat.

The upper harness system may further comprise at least one upper attachment strap, having a first end and a second end, attached to the carrier body at the upper end, wherein the first end further comprises a first releasable attachment mechanism for attaching to and detaching from the carrier body, and the second end further comprises an attachment mechanism for attaching to the car seat. The first end of the at least one upper attachment strap may further comprise a first fixed attachment strap having a first end and a second end, wherein the first end is attached to the carrier body and to a first adjustment mechanism, and the second end is adjustable by means of the first adjustment mechanism; and a second adjustment mechanism attached to the first end, for adjusting the length of the at least one upper attachment strap.

The middle harness system of the apparatus may further comprise a middle attachment strap having a first end and a second end, for attaching the carrier body to the car seat, wherein the first end is attached to the carrier body and the second end is attached to a second releasable attachment mechanism; and a second fixed attachment strap having a first end and a second end, wherein the first end is attached to the carrier body and the second end is attached to a third adjustment mechanism for adjusting the length of the middle harness system and thereby securing the carrier body to the car seat.

The wheeled assembly of the present invention may further comprise a telescoping handle for pulling the apparatus, a cross member supporting the handle, at least one vertical support member attached to the cross member, and a wheel system attached to the at least one vertical support member. The telescoping handle may further comprise a hand grip for the person to hold onto the wheeled assembly, a ratcheting system for extending and collapsing the telescoping handle, and a release lever for locking and unlocking the ratcheting system. The wheeled assembly may further comprise a support shelf disposed between the at least one vertical support member and the wheel system. At least one wheel may be rotatably disposed in the wheel system, however, the wheel system may also comprise two wheels.

The at least one attachment system of the present invention may further comprise an upper attachment system for attaching the wheeled assembly to the carrier body by securing the cross member; and a middle attachment system and a lower attachment system for attaching the wheeled assembly to the carrier body by securing the at least one vertical support member.

The upper attachment system may further comprise at least one upper strap system, the upper strap system further comprising: a first upper strap having a first end and a second end, for attaching the wheeled assembly to the carrier body, wherein the first end is attached to the carrier body and the second end is attached to a third releasable attachment mechanism; and a second upper strap having a first end and a second end, for attaching the wheeled assembly body to the carrier body, wherein the first end is attached to the carrier body and the second end also is attached to the third releasable attachment mechanism, thereby forming a loop in conjunction with the first upper strap; wherein the at least one upper strap system secures the cross member of the wheeled assembly. As disclosed herein, the upper attachment system may further comprises two upper strap systems, disposed on the carrier body substantially in parallel, securing the cross member of the wheeled assembly.

The middle attachment system of the present invention may further comprise at least one middle strap having a first end and a second end, for attaching the wheeled assembly to the carrier body, wherein the first end is attached to the carrier body and to a loop; wherein the second end is attached to a fourth releasable attachment mechanism; and wherein the second end secures the at least one vertical support member by passing back through the loop and attaching via the fourth releasable attachment mechanism. The middle attachment system may further comprise two middle straps, disposed on the carrier body substantially in parallel, securing two of the at least one vertical support member of the wheeled assembly.

The lower attachment system of the present invention may further comprise at least one lower strap having a first end and a second end, for attaching the wheeled assembly to the carrier body, wherein the first end is attached to the carrier body and to a loop; wherein the second end is attached to a fifth releasable attachment mechanism; and wherein the second end secures the at least one vertical support member by passing back through the loop and attaching via the fifth releasable attachment mechanism. The lower attachment system may further comprise two lower straps, disposed on the carrier body substantially in parallel, securing two of the at least one vertical support member of the wheeled assembly.

The carrier body may further comprises a front panel facing toward the wheeled assembly and a back panel facing toward the car seat, wherein the front panel and the back panel are attached to one another to form a pocket; a stiffening member shaped to fit inside the pocket, for providing support for the carrier body; and at least one semi-rigid stay attached to the stiffening member, for providing additional support for the carrier body.

The carrier body may further comprise at least one pouch attached to the stiffening member, having an opening, and wherein the at least one semi-rigid stay is inserted into the opening of the pouch.

The present invention contemplates that the apparatus may be integrated, into a factory design of the car seat or may be an after-market product separately available for attachment to the car seat. Or, in any combination, the at least one harness system, the carrier body, the wheeled assembly, and the at least one attachment system may be integrated into a factory design of the car seat.

The present invention is directed to an apparatus for transporting a car seat by a person, wherein the apparatus comprises a carrier body having an upper end and a lower end; at least one harness system attached to the carrier body, for attaching the carrier body to the car seat and to the person; a wheeled assembly, having a telescoping handle for pulling the apparatus, a cross member supporting the handle, at least one vertical support member attached to the cross member, and a wheel assembly attached to the at least one vertical support member, attached to the carrier body; at least one attachment system, for attaching the wheeled assembly to the carrier body; wherein the at least one harness system further comprises a middle harness system attached to the carrier body between the upper end and the lower end, for attaching the carrier body to the car seat; an upper harness system attached to the carrier body at the upper end, for further attaching the carrier body to the car seat; a shoulder harness system attached to the carrier body at the upper end and at the lower end, for securing the apparatus to the person; and wherein the at least one attachment system further comprises an upper attachment system attached to the carrier body at the upper end, for attaching the wheeled assembly to the carrier body by securing the cross member; and a middle attachment system attached to the carrier body between the upper and the lower ends, and a lower attachment system attached to the carrier body at the lower end, for attaching the wheeled assembly to the carrier body by securing the at least one vertical support member.

The shoulder harness system may further comprise at least one shoulder strap having an upper end and a lower end, for securing the apparatus to the person, wherein the upper end is attached to the upper end of the carrier body and the lower end is attached to the lower end of the carrier body; and at least one shoulder pad attached to the at least one shoulder strap. The at least one shoulder strap may further comprise a first shoulder strap having an upper end and a lower end; and a second shoulder strap having an upper end and a lower end.

The shoulder harness system may further comprise a chest strap having a first end and a second end, the first end attached to the first shoulder strap between the upper end and the lower end of the first shoulder strap by one of a fifth adjustment mechanism, and the second end attached to the second shoulder strap between the upper end and the lower end of the second shoulder strap by another of the fifth adjustment mechanism. The chest strap may further comprise first and second ends attached to a sixth releasable attachment mechanism; wherein the chest strap is adjustable along the first and second shoulder straps by means of the fifth adjustment mechanisms; and wherein the chest strap opens and closes by means of the sixth releasable attachment mechanism. The upper end of the at least one shoulder strap may further comprise an upper shoulder harness attachment strap attached to the upper end of the carrier body and to a sixth adjustment mechanism, and an upper shoulder harness adjustment strap attached to the sixth adjustment mechanism; wherein the lower end of the at least one shoulder strap further comprises a lower shoulder harness attachment strap attached to the lower end of the carrier body and to a seventh adjustment mechanism. A lower shoulder harness adjustment strap may be attached to the seventh adjustment mechanism, and the length of the at least one shoulder strap may be adjustable by means of the upper and lower shoulder harness adjustment straps.

The carrier apparatus may further comprise a hip harness system attached to the carrier body at the lower end, for further securing the apparatus to the person. The hip harness system may further comprises a hip belt having a first end and a second end, wherein the first end is attached to the carrier body and the second end is attached to a seventh releasable attachment mechanism, thereby securing the apparatus to the person, and wherein the hip belt opens and closes by means of the seventh releasable attachment mechanism; and a hip belt adjustment strap attached to the second end of the hip belt and to the seventh releasable attachment mechanism, for adjusting the length of the hip belt.

The present invention is also directed to an apparatus for transporting a car seat by a person, the apparatus comprising means for attaching the car seat to a wheeled assembly, and means for supporting the attachment means. The apparatus may further comprise means for securing the car seat to the wheeled assembly.

The attachment means may further comprise means for attaching the wheeled assembly at an upper area of the supporting means; means for attaching the wheeled assembly at a middle area of the supporting means; means for attaching the wheeled assembly at a lower area the supporting means; means for securing the supporting means to the car seat at an upper area of the car seat; and means for securing the supporting means to the car seat at a middle area of the car seat.

The present invention contemplates a design having at least one of the attachment means, the supporting means, and the securing means integrated into a factory design of the car seat.

The present invention is also directed to a method for transporting a car seat by a person, comprising the following steps: providing a wheeled assembly, having a telescoping handle for pulling the apparatus, a cross member supporting the handle, at least one vertical support member attached to the cross member, and a wheel system attached to the at least one vertical support member for wheeling the car seat on the ground; providing at least one attachment system for attaching the wheeled assembly to the car seat; providing a carrier body, having an upper end and a lower end, for supporting the at least one attachment system; and providing at least one harness system for attaching the car seat to the carrier body.

The method of the present invention may further comprise the following steps: providing an upper harness system attached to the carrier body at the upper end; providing a middle harness system attached to the carrier body between the upper end and the lower end; providing an upper attachment system for attaching the wheeled assembly to the carrier body by securing the cross member; and providing a middle attachment system and a lower attachment system for attaching the wheeled assembly to the carrier body by securing the at least one vertical support member.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

FIG. 1 is a perspective view of an apparatus for transporting a car seat according to an embodiment of the present invention, having a carrier body, a wheeled carrier, and a plurality of harness and attachment systems to attach the wheeled carrier to the carrier body and the carrier body to the car seat.

FIG. 2 is a perspective view of an apparatus for transporting a car seat, having an upper harness system, a middle harness system, an upper attachment system, a middle attachment system, and a lower attachment system, according to an embodiment of the present invention.

FIG. 3 is a front view of an apparatus for transporting a car seat, having a wheeled carrier attached to a carrier body, according to an embodiment of the present invention.

FIG. 4 is a rear view of an apparatus for transporting a car seat, having a wheeled carrier attached to a carrier body, according to an embodiment of the present invention.

FIG. 5 is a perspective view of an apparatus for transporting a car seat, having a middle harness system for attaching the apparatus to a car seat, according to an embodiment of the present invention.

FIG. 6 is a perspective view of an apparatus for transporting a car seat, having an internal stiffening member, according to an embodiment of the present invention.

FIG. 7 is a perspective view of an apparatus for transporting a car seat, having internal stays, according to an embodiment of the present invention.

FIG. 8 is a perspective view of an apparatus for transporting a car seat, having a plurality of harness systems for carrying a car seat on a user's back and a plurality of straps for attaching a wheeled carrier for wheeling a car seat on the ground, according to an alternate embodiment of the present invention.

FIG. 9 is a perspective view of a person using the apparatus of the present invention to transport a car seat along with an infant or child buckled in the car seat.

### DETAILED DESCRIPTION OF THE INVENTION

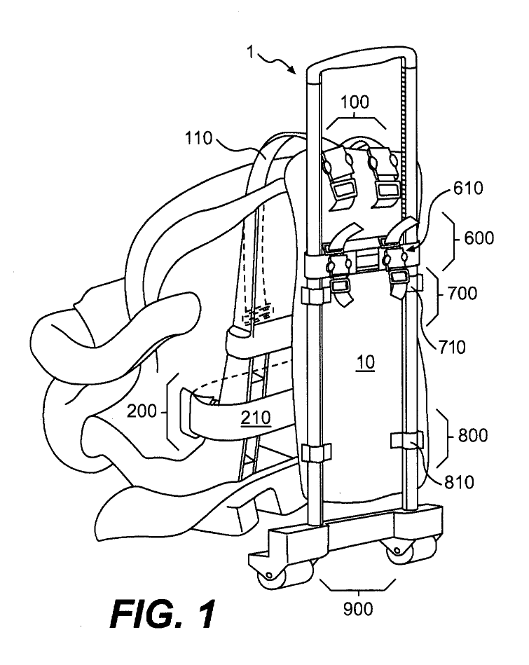

Referring now to FIG. 1, a preferred embodiment of the present invention is shown as carrier apparatus 1. Carrier apparatus 1 preferably comprises carrier body 10, upper harness system 100, middle harness system 200, upper attachment system 600, middle attachment system 700, lower attachment system 800, and wheeled carrier 900. Carrier body 10 may be fabricated from any of a variety of materials that provide adequate strength and flexibility to support the load of a car seat, or car seat together with an infant or child. Examples include various types of nylon cordura cloth, polyester duck, nylon pack cloth, or other suitable materials. Upper harness system 100, middle harness system 200, upper attachment system 600, middle attachment system 700, and lower attachment system 800 may be fabricated from any of a variety of straps and padding materials that provide adequate strength and flexibility to support the load of a car seat, or car seat together with an infant or child. Examples include nylon webbing, polypropylene webbing, nylike webbing or other suitable materials. Such materials are well known and are readily available in a variety of sizes and configurations. Wheeled carrier 900 may be any one of a variety of commercially available wheeled luggage carriers.

Upper harness system 100 together with middle harness system 200 serve to attach carrier body 10 to a child's or infant's car seat. Upper attachment system 600, middle attachment system 700, and lower attachment system 800 preferably attach carrier body 10 to wheeled carrier 900. With continuing reference to FIG. 1, upper harness system 100 preferably further comprises upper attachment strap 110, middle harness system 200 preferably further comprises middle attachment strap 210, upper attachment system 600 preferably further comprises upper strap system 610, middle attachment system 700 preferably further comprises middle strap 710, and lower attachment system 800 preferably further comprises lower strap 810.

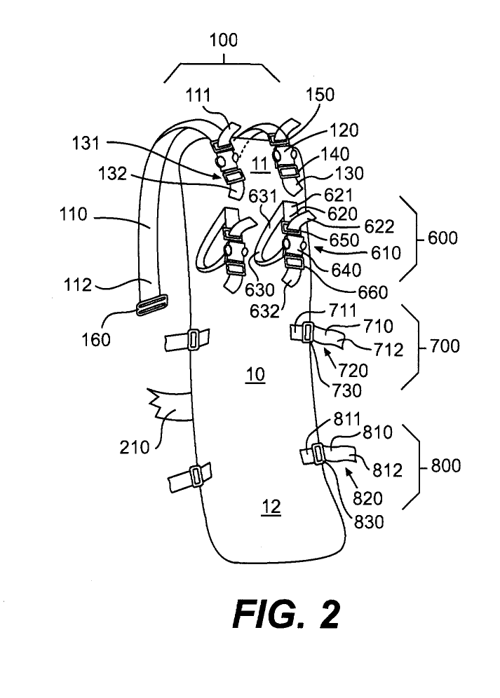

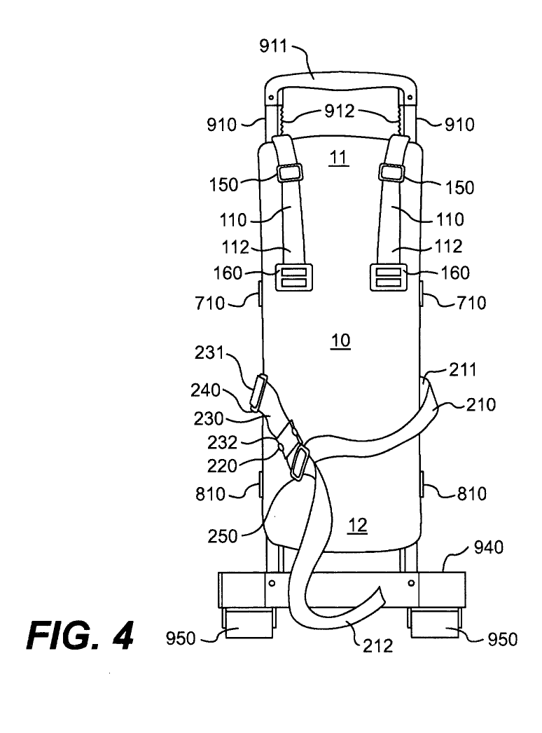

Referring now to FIGS. 2 and 4, upper attachment strap 110 preferably has a first end 111 and a second end 112. Upper attachment strap 110 preferably is attached to first releasable attachment mechanism 120 at upper attachment strap first end 111. First releasable attachment mechanism 120 may be any suitable mechanism that permits upper attachment strap 110 to be attached and released without slipping or accidental release. Examples of suitable mechanisms include side release type buckles and hook-and-loop closures, however, the present invention is not limited to these mechanisms. As embodied herein, carrier apparatus 1 preferably comprises two upper attachment straps 110, attached symmetrically at upper end 11 of carrier body 10 by two first releasable attachment mechanisms 120.

First releasable attachment mechanism 120 may be attached to carrier body 10 by first fixed attachment strap 130 in conjunction with first adjustment mechanism 140, as shown in FIG. 2. In this embodiment, first fixed attachment strap 130 further comprises first end 131 and second end 132. First end 131 of first fixed attachment strap 130 preferably is sewn or otherwise attached to carrier body 10. Second end 132 of first fixed attachment strap 130 preferably is fed through first adjustment mechanism 140, such that first fixed attachment strap 130 can be lengthened or shortened. First adjustment mechanism 140 may be any suitable mechanism that permits first fixed attachment strap 130 to be shortened and lengthened without slipping or accidental release. Examples of suitable mechanisms include tri glide type buckles and hook-and-loop closures, however, the present invention is not limited to these mechanisms.

With reference to FIGS. 1, 2, and 4, upper attachment strap 110, at first end 111, may be provided with second adjustment mechanism 150. Second adjustment mechanism 150 is attached to first releasable attachment mechanism 120. Second adjustment mechanism 150 may be any suitable mechanism that permits upper attachment strap 110 to be shortened and lengthened without slipping or accidental release. Examples of suitable mechanisms include tri glide type buckles and hook-and-loop closures, however, the present invention is not limited to these mechanisms.

Upper attachment strap 110 may be lengthened or shortened by adjusting first adjustment mechanism 140 alone, adjusting second adjustment mechanism 150 alone, or adjusting first adjustment mechanism 140 and second adjustment mechanism 150 in combination.

Each second end 112 of the two upper attachment straps 110 preferably is provided with attachment mechanism 160. Car seats typically are provided with two or more holes or slots in the molded plastic back, through which the car seat shoulder harness straps feed from the back of the car seat to the seat portion, securing the infant or child in the car seat. Attachment mechanism 160 may be any mechanism suitable for anchoring upper attachment straps 110 to a car seat, such that attachment mechanism 160 does not slip out of the car seat slots; for example, a metal tri glide type buckle or a metal locking clip of the type used to secure the seat belt that attaches a car seat in a vehicle. Other attachment mechanisms that provide the same functionality are considered to be within the scope of the present invention.

Referring now to FIGS. 1, 4 and 5, carrier apparatus 1 preferably further comprises middle harness system 200. Middle harness system 200 preferably comprises middle attachment strap 210, having first end 211 and second end 212; second releasable attachment mechanism 220; second fixed attachment strap 230, having first end 231 and second end 232; third adjustment mechanism 240, and fourth adjustment mechanism 250. First end 211 of middle attachment strap 210 preferably is sewn or otherwise attached to carrier body 10. Second end 212 of middle attachment strap 210 preferably is attached to second releasable attachment mechanism 220. Second releasable attachment mechanism 220 preferably is attached to second fixed attachment strap 230, which in turn is threaded through third adjustment mechanism 240. Second releasable attachment mechanism 220 may be any suitable mechanism that permits middle attachment strap 210 to be attached and released without slipping or accidental release. Examples of suitable mechanisms include side release type buckles and hook-and-loop closures, however, the present invention is not limited to these mechanisms.

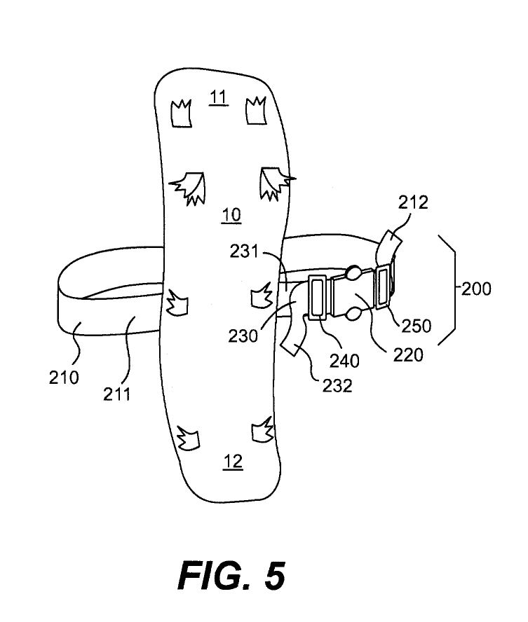

First end 231 of second fixed attachment strap 230 preferably is sewn or otherwise attached to carrier body 10 as shown in FIG. 5. Second end 232 of second fixed attachment strap 230 preferably is threaded through third adjustment mechanism 240, such that second fixed attachment strap 230 can be lengthened or shortened. As with second fixed attachment strap 230, second end 212 of middle attachment strap 210 may be threaded through fourth adjustment mechanism 240, such that middle attachment strap 210 can be lengthened or shortened. Third adjustment mechanism 240 and fourth adjustment mechanism 250 may be any suitable mechanism that permits second fixed attachment strap 230 and middle attachment strap 210 to be shortened and lengthened without slipping or accidental release. Examples of suitable mechanisms include tri glide type buckles and hook-and-loop closures, however, the present invention is not limited to these mechanisms.

In addition to the shoulder harness strap slots described above, car seats typically are provided with one or more large holes or slots in the molded plastic back, through which the vehicle seat belt may be threaded and attached to the seat belt buckle, thereby securing the car seat in the vehicle. Carrier body 10 preferably is attached to a car seat by threading middle harness system 200 through the seat belt holes or holes.

As embodied herein, carrier body 10 preferably is attached to a car seat by both upper harness system 100 and middle harness system 200. To attach upper harness system 100, upper attachment straps 110 preferably are attached to a car seat by means of attachment mechanism 160. Two attachment mechanisms 160 preferably are inserted through two of the factory-made car seat shoulder harness slots, such that the attachment mechanisms 160 are secure and do not slip out. To attach middle harness system 200, second releasable attachment mechanism 220 is opened, so that middle attachment strap 210 can be threaded through the car seat seat belt hole or holes, and then second releasable attachment mechanism 220 is fastened. Middle harness system 200 may be tightened by the user by pulling either middle attachment strap 210 second end 212 through fourth adjustment mechanism 250, second fixed attachment strap 230 second end 232 through third adjustment mechanism 240, or by a combination of both. The present invention is designed to provide a secure connection between carrier apparatus 1 and a car seat, by means of the adjustability of upper harness system 100 and middle harness system 200.

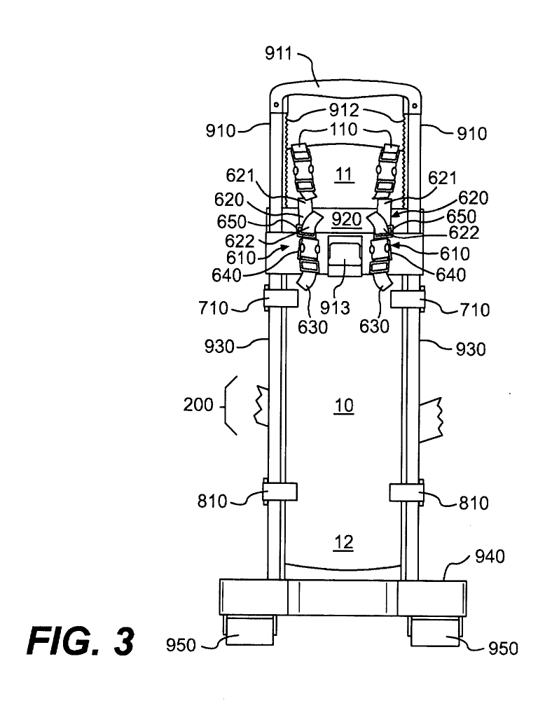

As embodied herein, carrier apparatus 1 is provided with wheeled carrier 900, so that an attached car seat or car seat plus child may easily be wheeled on the ground. Wheeled carrier 900 may be any one of a variety of commercially available wheeled luggage carriers. The scope of the present invention contemplates using any wheeled luggage carrier that provides the functionality described herein, and is not limited to the representative wheeled carrier described below. Referring now to FIGS. 1 and 3, wheeled carrier 900 preferably comprises telescoping handle 910, hand grip 911, ratcheting system 912, release lever 913, cross member 920, at least one vertical support member 930, support shelf 940, and wheel assembly 950.

When telescoping handle 910 is in a collapsed, or closed position, it may be extended, or raised, by unlocking release lever 913 and then pulling upward on hand grip 911. Ratcheting system 912 permits telescoping handle 910 to be extended to a wide range of heights, so that wheeled carrier 900 can be adjusted to fit any size of car seat, and is comfortable for a user of any height.

Telescoping handle 910 is attached to cross member 920, which as part of the frame of wheeled carrier 900 provides support for telescoping handle 910 and at least one vertical support member 930. As embodied herein, wheeled carrier 900 preferably comprises two vertical support members 930, substantially parallel to each other and connected at their bases to support shelf 940. Support shelf 940 preferably provides rotatable attachment for wheeled assembly 950, which, as embodied herein, preferably comprises two wheels.

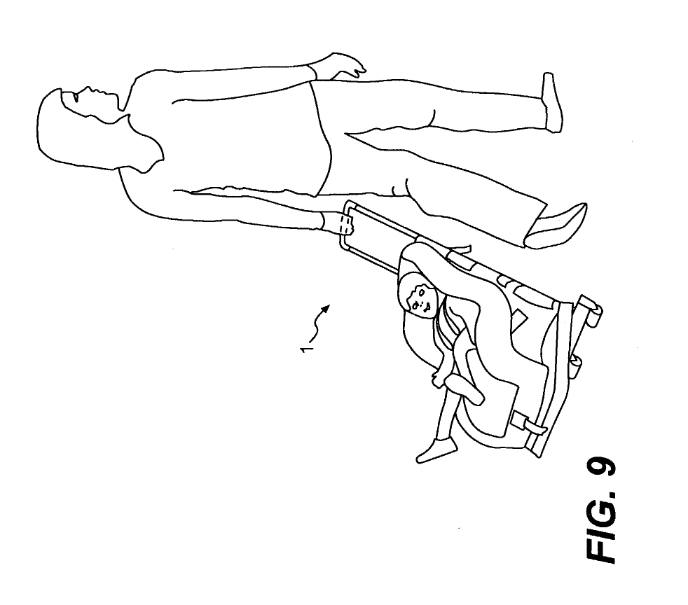

The attachment of carrier apparatus 1, with a car seat secured thereto by upper harness system 100 and middle harness system 200, to wheeled carrier 900 will now be described. A user transporting a car seat by means of the present invention, with an infant or child secured therein, is shown in FIG. 9. In this illustration, the carrier apparatus is wheeled on the ground by the user. It is contemplated by the present invention, however, that the carrier apparatus may also be carried on the user's back, front or chest, as will be described in more detail below. Carrier apparatus 1 preferably is attached to wheeled carrier 900 via upper attachment system 600, middle attachment system 700, and lower attachment system 800, as shown in FIG. 1.

Referring now to FIGS. 2 and 3, upper attachment system 600 preferably further comprises at least one upper strap system 610, which serves to attach wheeled carrier 900 by securing cross member 920. Upper strap system 610 preferably comprises first upper strap 620, having a first end 621 and a second end 622, and second upper strap 630, having a first end 631 and a second end 632. First upper strap 620 and second upper strap 630 preferably are sewn or otherwise attached to upper end 11 of carrier body 10, by respectively, first upper strap first end 621 and second upper strap first end 631. Second end 622 of first upper strap 620 preferably is attached to one end of third releasable attachment mechanism 640 and then threaded through fourth adjustment mechanism 650. Third releasable attachment mechanism 640 may be any suitable mechanism that permits first upper strap 620 to be released and refastened without slipping or accidental release. Examples of suitable mechanisms include side release type buckles and hook-and-loop closures, however, the present invention is not limited to these mechanisms. Fourth adjustment mechanism 650 may be any suitable mechanism that permits first upper strap 620 to be shortened and lengthened without slipping or accidental release. Examples of suitable mechanisms include tri glide type buckles and hook-and-loop closures, however, the present invention is not limited to these mechanisms.

As embodied herein, second end 632 of second upper strap 630 preferably is attached to the other end of third releasable attachment mechanism 640 and then threaded through fifth adjustment mechanism 660. Fifth adjustment mechanism 660 may be any suitable mechanism that permits second upper strap 630 to be shortened and lengthened without slipping or accidental release. Examples of suitable mechanisms include tri glide type buckles and hook-and-loop closures, however, the present invention is not limited to these mechanisms. Together, first upper strap 620 and second upper strap 630 form an adjustable loop, connected by third releasable attachment mechanism 640, that is designed to be tightened so that it fits snugly around cross member 920, and secures wheeled carrier 900 to carrier body 10.

As embodied herein, upper attachment system 600 preferably comprises two upper strap systems 610, attached to carrier body 10 substantially parallel to each other, and spaced so as to fit around either end of cross member 920.

With continuing reference to FIGS. 2 and 3, carrier body 10 preferably is further provided with middle attachment system 700. Middle attachment system 700 preferably comprises at least one middle strap 710, having first end 711 and second end 712. First end 711 preferably is sewn or otherwise attached to carrier body 11 at a middle point between upper end 11 and lower end 12. Second end 712 of middle strap 710 is provided with fourth releasable attachment mechanism 720. Fourth releasable attachment mechanism 720 may be any suitable mechanism that permits middle strap 710 to be fastened back on itself. An example of a suitable mechanism includes and hook-and-loop closures, however, the present invention is not limited to this mechanism. Middle strap 710 preferably is further provided with loop 730, such that second end 712 may be wrapped snugly around vertical support member 930, pass through loop 730, and fasten back upon itself. Loop 730 may be any suitable device that permits middle strap 710 to fold back on itself. A preferred example of a suitable deice is a looploc buckle, however, the present invention is not limited to this device.

As embodied herein, middle attachment system 700 preferably comprises two middle straps 710, attached to carrier body 10 substantially parallel to each other, and spaced so as to fit around each of two vertical support members 930.

With continuing reference to FIGS. 2 and 3, carrier body 10 preferably is further provided with lower attachment system 800. Lower attachment system 800 preferably comprises at least one middle strap 810, having first end 811 and second end 812. First end 811 preferably is sewn or otherwise attached to carrier body 11 at lower end 12. Second end 812 of middle strap 810 is provided with fifth releasable attachment mechanism 820. Fifth releasable attachment mechanism 820 may be any suitable mechanism that permits middle strap 810 to be fastened back on itself. An example of a suitable mechanism includes and hook-and-loop closures, however, the present invention is not limited to this mechanism. Middle strap 810 preferably is further provided with loop 830, such that second end 812 may be wrapped snugly around vertical support member 930, pass through loop 830, and fasten back upon itself. Loop 830 may be any suitable device that permits lower strap 810 to fold back on itself. A preferred example of a suitable device is a looploc buckle, however, the present invention is not limited to this device.

As embodied herein, middle attachment system 800 preferably comprises two middle straps 810, attached to carrier body 10 substantially parallel to each other, and spaced so as to fit around each of two vertical support members 930.

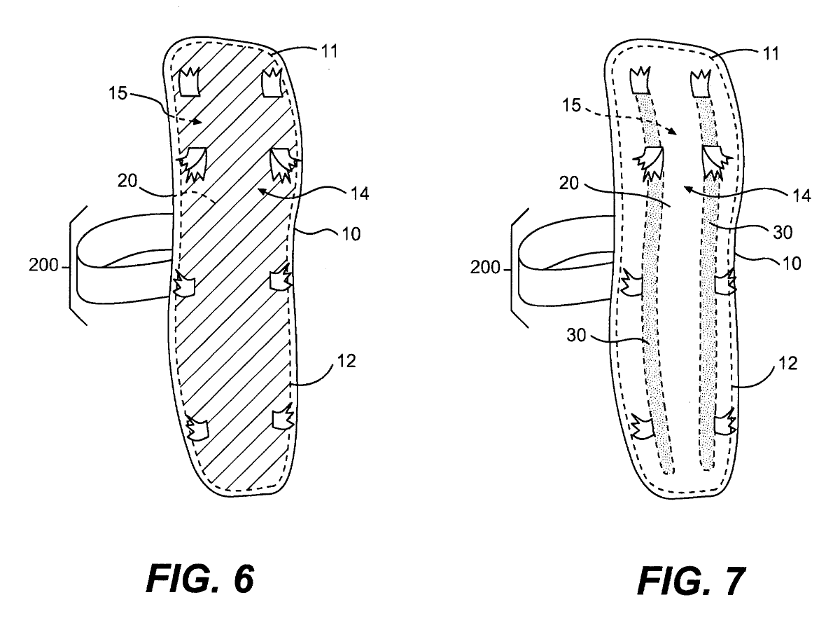

As embodied herein, carrier body 10 is further provided with internal structures that are designed to increase the stability of carrier body 10, and thereby improve the load-carrying capacity of carrier apparatus 1. Referring now to FIG. 6, carrier body 10 preferably further comprises front panel 14 and back panel 15, which may be sewn, glued, or otherwise attached around the edges, creating a pocket (not shown). Front panel 14 preferably is covered with a mesh aerospacer or similar material. Carrier body 10 preferably further is provided with an opening (not shown), closable by a zipper (not shown), through which internal structures preferably are inserted into the pocket.

Carrier body 10 preferably further comprises stiffening member 20. Stiffening member 20 may be fabricated from fiberglass or high-density polyethylene plastic. Such materials are well known and are readily available. Stiffening member 20 preferably is a thin sheet that is shaped to fit inside the pocket created by front panel 14 and back panel 15 of carrier body 10. Stiffening member 20 may extend the length of carrier body 10 from upper end 11 to lower end 12, or may be of any other shape, length or configuration that is desirable for support, comfort, or other purposes. As embodied herein, stiffening member 20 may be inserted through the zippered opening in carrier body 10, and likewise removed.

Referring now to FIG. 7, carrier body 10 preferably further comprises at least one stay 30. Stay 30 preferably is a flattened, elongated bar, and may be encased in a plastic covering for ease of handling and insertion. Stay 30 preferably is fabricated from aluminum, however, titanium, steel, or other suitable metal, or plastic or another suitable material may be used. As embodied herein, stay 30 may be inserted into a pouch (not shown) of the same shape as the stay. The pouch may be fabricated from any suitable fabric or material, and may be sewn, glued or otherwise attached to stiffening member 20. Other means of attaching to stiffening member 20 or inserting stay 30 into carrier body 10 are contemplated by and considered to be within the scope of the present invention. As shown in FIG. 7, carrier body 10 is preferably provided with two stays 30, arranged vertically on either side of stiffening member 20, within carrier body 10. Stay 30 may extend the length of carrier body 10 from upper end 11 to lower end 12, or may be of any other shape, length or configuration that is desirable for support, comfort, or other purposes. In combination, stiffening member 20 and stays 30 provide a contoured, semi-rigid body frame. This contoured platform supports the load of the attached car seat, or attached car seat plus infant or child, and serves to distribute the load over a larger area.

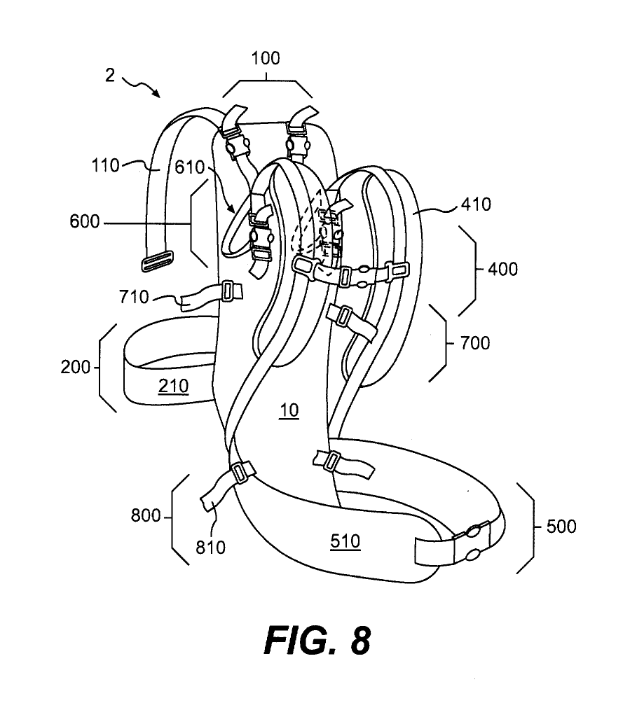

Referring now to FIG. 8, an alternate embodiment of the present invention is shown as carrier apparatus 2. In this embodiment, the user may attach a car seat to carrier apparatus 2 by means of the upper harness system 100 and middle harness system 200 as described above. The user may either carry the car seat on his or her back, or may wheel the car seat on the ground.

As embodied herein, carrier apparatus 2 preferably further comprises shoulder harness system 400 and hip harness system 500. Shoulder harness system 400 preferably further comprises shoulder strap 410. As embodied herein, carrier apparatus 2 preferably comprises two shoulder straps 410, attached symmetrically at upper end 11 of carrier body 10. As shown in FIG. 8, the two shoulder straps 410 are parallel to each other, however the present invention contemplates that shoulder straps 410 could be provided crossing each other. The present invention contemplates other embodiments (not shown) utilizing a single strap mounted on one side of or diagonally across carrier body 10. Other configurations that provide comfort, ease of use, economical manufacture, or other advantages are considered to be within the scope of the present invention.

Hip harness system 500 preferably further comprises hip belt 510, which preferably is attached to carrier body 10 at lower end 11. Proper adjustment of hip belt 510 may substantially assist with carrying a heavy load of a car seat plus infant or child. It is contemplated by the present invention, however, that hip harness system 500 may be detachable, and therefore used at the option of the user.

Shoulder harness system 400 together with hip harness system 500 preferably permit carrier body 10 and an attached car seat to be carried comfortably on the user's back.

Carrier apparatus 2 preferably further comprises upper attachment system 600, middle attachment system 700, and lower attachment system 800 which preferably attach carrier body 10 to wheeled carrier 900 as described above. When wheeled carrier 900 is thus attached, the user may wheel the car seat, or car seat plus child, over the ground.

In a second alternate embodiment (not shown), the present invention is directed to a design wherein the wheeled component comprises wheeled carrier 900, which preferably is attached directly to upper harness system 100 by means of fasteners (not shown). The fasteners may be any suitable means, such as bolts, rivets, or metal pins, that securely attaches wheeled carrier 900 directly to upper harness system 100. Upper harness system 100 may be any suitable attachment system, such as nylon webbing or elastic cords. In this embodiment, wheeled carrier 900 may also be directly attached to middle harness system 200 by any suitable means of bolt, rivet, or metal pin, as above. Preferably, middle attachment strap 210 is attached at one side of wheeled carrier 900 to one vertical support member 930, and at the other side of wheeled carrier 900 to the other vertical support member 930. In this embodiment, the rigid frame components of wheeled carrier 900, namely cross member 920, at least one vertical support member 930, and support shelf 940, replace the support function of carrier body 10. Thus carrier body 10 is unnecessary, and the resulting design is lighter, less complicated to use, and less expensive.

It will be apparent to those skilled in that art that various modifications and variations can be made in the fabrication and configuration of the present invention without departing from the scope and spirit of the invention. For example, one or more of the harness systems described above may be altered as to the number and placement of straps, adjustment mechanisms and attachment mechanisms. Further, the shape and placement of the stiffening member and stays in the carrier body may be altered to achieve desired comfort or load carry capacity objectives. A variety of materials may be used to fabricate the components of the apparatus of the invention. Also, the hip harness system may be detachable.

In addition, one or more of the harness systems or components thereof may be integrated into the factory design of a car seat, rather than being separately purchased as an after-market product. In particular, it may be desirable to manufacture a car seat with the upper attachment straps and attachment mechanism pre-attached to the car seat. In this configuration, the upper attachment straps would attach to and detach from the carrier body of the present invention. Further, it may be desirable to integrate the wheeled carrier or components thereof into the factory design of a car seat. In particular, a telescoping handles and wheels may be integrated into the car seat design. Thus, it is intended that the present invention cover the modifications and variations of the invention provided they come within the scope of the appended claims and their equivalents.

What is claimed is:

1. An apparatus for transporting a car seat by a person, said apparatus comprising:
a carrier body having an upper end and a lower end;
a wheeled assembly disposed on said carrier body at said lower end;
at least one harness system attached to said carrier body, for attaching said carrier body to said car seat.

2. The apparatus of claim 1, further comprising at least one attachment system, for attaching said wheeled assembly to said carrier body.

3. The apparatus of claim 1, wherein said at least one harness system further comprises:
a middle harness system attached to said carrier body between said upper end and said lower end, for attaching said carrier body to said car seat.

4. The apparatus of claim 3, wherein said at least one harness system further comprises:
an upper harness system attached to said carrier body at said upper end, for further attaching said carrier body to said car seat.

5. The apparatus of claim 4, wherein said upper harness system further comprises:
at least one upper attachment strap, having a first end and a second end, attached to said carrier body at said upper end, wherein said first end further comprises a first releasable attachment mechanism for attaching to and detaching from said carrier body, and said second end further comprises an attachment mechanism for attaching to said car seat.

6. The apparatus of claim 5, wherein said first end of said at least one upper attachment strap further comprises:
a first fixed attachment strap having a first end and a second end, wherein said first end is attached to said carrier body and to a first adjustment mechanism, and said second end is adjustable by means of said first adjustment mechanism; and
a second adjustment mechanism attached to said first end, for adjusting the length of said at least one upper attachment strap.

7. The apparatus of claim 3, wherein said middle harness system further comprises:
a middle attachment strap having a first end and a second end, for attaching said carrier body to said car seat, wherein said first end is attached to said carrier body and said second end is attached to a second releasable attachment mechanism;
a second fixed attachment strap having a first end and a second end, wherein said first end is attached to said carrier body and said second end is attached to a third adjustment mechanism for adjusting the length of said middle harness system and thereby securing said carrier body to said car seat.

8. The apparatus of claim 1, wherein said wheeled assembly further comprises a telescoping handle for pulling said apparatus, a cross member supporting said handle, at least one vertical support member attached to said cross member, and a wheel system attached to said at least one vertical support member.

9. The apparatus of claim 8, wherein said telescoping handle further comprises a hand grip for said person to hold onto said wheeled assembly, a ratcheting system for extending and collapsing said telescoping handle, and a release lever for locking and unlocking said ratcheting system.

10. The apparatus of claim 9, wherein said wheeled assembly further comprises a support shelf disposed between said at least one vertical support member and said wheel system.

11. The apparatus of claim 10, wherein at least one wheel is rotatably disposed in said wheel system.

12. The apparatus of claim 11, wherein said wheel system further comprises two wheels.

13. The apparatus of claim 11, wherein said at least one attachment system further comprises:
an upper attachment system for attaching said wheeled assembly to said carrier body by securing said cross member; and
a middle attachment system and a lower attachment system for attaching said wheeled assembly to said carrier body by securing said at least one vertical support member.

14. The apparatus of claim 13, wherein said upper attachment system further comprises at least one upper strap system, said upper strap system further comprising:
a first upper strap having a first end and a second end, for attaching said wheeled assembly to said carrier body, wherein said first end is attached to said carrier body and said second end is attached to a third releasable attachment mechanism; and
a second upper strap having a first end and a second end, for attaching said wheeled assembly body to said carrier body, wherein said first end is attached to said carrier body and said second end also is attached to said third releasable attachment mechanism, thereby forming a loop in conjunction with said first upper strap;
wherein said at least one upper strap system secures said cross member of said wheeled assembly.

15. The apparatus of claim 14, wherein said upper attachment system further comprises two upper strap systems, disposed on said carrier body substantially in parallel, securing said cross member of said wheeled assembly.

16. The apparatus of claim 13, wherein said middle attachment system further comprises at least one middle strap having a first end and a second end, for attaching said wheeled assembly to said carrier body, wherein said first end is attached to said carrier body and to a loop; wherein said second end is attached to a fourth releasable attachment mechanism; and wherein said second end secures said at least one vertical support member by passing back through said loop and attaching via said fourth releasable attachment mechanism.

17. The apparatus of claim 16, wherein said middle attachment system further comprises two middle straps, disposed on said carrier body substantially in parallel, securing two of said at least one vertical support member of said wheeled assembly.

18. The apparatus of claim 13, wherein said lower attachment system further comprises at least one lower strap having a first end and a second end, for attaching said wheeled assembly to said carrier body, wherein said first end is attached to said carrier body and to a loop; wherein said second end is attached to a fifth releasable attachment mechanism; and wherein said second end secures said at least one vertical support member by passing back through said loop and attaching via said fifth releasable attachment mechanism.

19. The apparatus of claim 18, wherein said lower attachment system further comprises two lower straps, disposed on said carrier body substantially in parallel, securing two of said at least one vertical support member of said wheeled assembly.

20. The apparatus of claim 1, wherein said carrier body further comprises:
a front panel facing toward said wheeled assembly and a back panel facing toward said car seat, wherein said front panel and said back panel are attached to one another to form a pocket;
a stiffening member shaped to fit inside said pocket, for providing support for said carrier body; and
at least one semi-rigid stay attached to said stiffening member, for providing additional support for said carrier body.

21. The apparatus of claim 20, wherein said carrier body further comprises:
at least one pouch attached to said stiffening member, having an opening, and wherein said at least one semi-rigid stay is inserted into said opening of said pouch.

22. The apparatus of claim 1, wherein said apparatus is integrated into a factory design of said car seat.

23. The apparatus of claim 1, wherein said apparatus is an after-market product separately available for attachment to said car seat.

24. The apparatus of claim 2, wherein at least one of said at least one harness system, said carrier body, said wheeled assembly, and said at least one attachment system is integrated into a factory design of said car seat.

25. An apparatus for transporting a car seat by a person, said apparatus comprising:
a carrier body having an upper end and a lower end;
at least one harness system attached to said carrier body, for attaching said carrier body to said car seat and to said person;
a wheeled assembly, having a telescoping handle for pulling said apparatus, a cross member supporting said handle, at least one vertical support member attached to said cross member, and a wheel assembly attached to said at least one vertical support member, attached to said carrier body;
at least one attachment system, for attaching said wheeled assembly to said carrier body;
wherein said at least one harness system further comprises:
a middle harness system attached to said carrier body between said upper end and said lower end, for attaching said carrier body to said car seat;
an upper harness system attached to said carrier body at said upper end, for further attaching said carrier body to said car seat;
a shoulder harness system attached to said carrier body at said upper end and at said lower end, for securing said apparatus to said person;
and wherein said at least one attachment system further comprises:
an upper attachment system attached to said carrier body at said upper end, for attaching said wheeled assembly to said carrier body by securing said cross member; and
a middle attachment system attached to said carrier body between said upper and said lower ends, and a lower attachment system attached to said carrier body at said lower end, for attaching said wheeled assembly to said carrier body by securing said at least one vertical support member.

26. The apparatus of claim 25, further comprising a hip harness system attached to said carrier body at said lower end, for further securing said apparatus to said person;

27. The apparatus of claim 25, wherein said shoulder harness system further comprises:
at least one shoulder strap having an upper end and a lower end, for securing said apparatus to said person, wherein said upper end is attached to said upper end of said carrier body and said lower end is attached to said lower end of said carrier body; and
at least one shoulder pad attached to said at least one shoulder strap.

28. The apparatus of claim 27, wherein said at least one shoulder strap further comprises:
a first shoulder strap having an upper end and a lower end; and
a second shoulder strap having an upper end and a lower end.

29. The apparatus of claim 28, wherein said shoulder harness system further comprises:
a chest strap having a first end and a second end, said first end attached to said first shoulder strap between said upper end and said lower end of said first shoulder strap by one of a fifth adjustment mechanism, and said second end attached to said second shoulder strap between said upper end and said lower end of said second shoulder strap by another of said fifth adjustment mechanism, wherein said chest strap further comprises said first and second ends attached to a sixth releasable attachment mechanism;
wherein said chest strap is adjustable along said first and second shoulder straps by means of said fifth adjustment mechanisms;
wherein said chest strap opens and closes by means of said sixth releasable attachment mechanism;
wherein said upper end of said at least one shoulder strap further comprises an upper shoulder harness attachment strap attached to said upper end of said carrier body and to a sixth adjustment mechanism, and an upper shoulder harness adjustment strap attached to said sixth adjustment mechanism;
wherein said lower end of said at least one shoulder strap further comprises a lower shoulder harness attachment strap attached to said lower end of said carrier body and to a seventh adjustment mechanism, and a lower shoulder harness adjustment strap attached to said seventh adjustment mechanism; and
wherein the length of said at least one shoulder strap is adjustable by means of said upper and lower shoulder harness adjustment straps.

30. The apparatus of claim 26, wherein said hip harness system further comprises:
a hip belt having a first end and a second end, wherein said first end is attached to said carrier body and said second end is attached to a seventh releasable attachment mechanism, thereby securing said apparatus to said person, wherein said hip belt opens and closes by means of said seventh releasable attachment mechanism; and
a hip belt adjustment strap attached to said second end of said hip belt and to said seventh releasable attachment mechanism, for adjusting the length of said hip belt.

31. An apparatus for transporting a car seat by a person, said apparatus comprising:
means for attaching said car seat to a wheeled assembly; and
means for supporting said attachment means.

32. The apparatus of claim 31, further comprising means for securing said car seat to said wheeled assembly.

33. The apparatus of claim 31, wherein said attachment means further comprises:
means for attaching said wheeled assembly at an upper area of said supporting means;
means for attaching said wheeled assembly at a middle area of said supporting means;
means for attaching said wheeled assembly at a lower area said supporting means;
means for securing said supporting means to said car seat at an upper area of said car seat; and
means for securing said supporting means to said car seat at a middle area of said car seat.

34. The apparatus of claim 33, wherein at least one of said attachment means, said supporting means, and said securing means is integrated into a factory design of said car seat.

35. A method for transporting a car seat by a person, comprising the following steps:
providing a wheeled assembly, having a telescoping handle for pulling said apparatus, a cross member supporting said handle, at least one vertical support member attached to said cross member, and a wheel system attached to said at least one vertical support member for wheeling said car seat on the ground;
providing at least one attachment system for attaching said wheeled assembly to said car seat;
providing a carrier body, having an upper end and a lower end, for supporting said at least one attachment system;
providing at least one harness system for attaching said car seat to said carrier body.

36. The method of claim 35, further comprising the following steps:
providing an upper harness system attached to said carrier body at said upper end;
providing a middle harness system attached to said carrier body between said upper end and said lower end;
providing an upper attachment system for attaching said wheeled assembly to said carrier body by securing said cross member; and
providing a middle attachment system and a lower attachment system for attaching said wheeled assembly to said carrier body by securing said at least one vertical support member.
